(19) United States
(12) Patent Application Publication
(10) Pub. No.: US 2014/0246975 A1
(43) Pub. Date: Sep. 4, 2014

(54) VEHICLE HEADLAMP CONTROL SYSTEM

(71) Applicant: Shinichi Futamura, Kuwana-shi (JP)

(72) Inventor: Shinichi Futamura, Kuwana-shi (JP)

(73) Assignee: DENSO CORPORATION, Kariya-city, Aichi-pref. (JP)

(21) Appl. No.: 14/241,504

(22) PCT Filed: Jul. 18, 2012
(86) PCT No.: PCT/JP2012/068199

§ 371 Date: May 9, 2014

(30) Foreign Application Priority Data
Aug. 29, 2011 (JP) 2011-186165

(51) Int. Cl. B60Q 1/00; B60Q 1/12; B60Q 1/08

(52) U.S. Cl. CPC B60Q 1/0023; B60Q 1/08; B60Q 1/12
USPC 315/82

(57) ABSTRACT

Position information of a light source is acquired from an image sensor, which images surroundings of a vehicle, detects the light source based on an acquired image, and outputs the position information of the light source (step 110), determines based on the acquired position information of the light source whether or not there is a light source within a traveling direction range of the vehicle, that is determined in accordance with a detected value of a steering angle or a yaw rate of the vehicle (step 120), controls an irradiation direction of the headlamp to follow a direction of the light source if a determination result of the means for determining is positive (step 140), and controls the headlamp independently from the position of the light source if a determination result of the means for determining is negative (steps 150, 155).

### TECHNICAL FIELD

The present invention relates to a vehicle headlamp control system.

### BACKGROUND ART

Conventionally, a technology that detects the position of a light source based on an image acquired by an on-vehicle camera, and controls an irradiation direction of a headlamp of a vehicle to be towards the detected position is known (Refer to Patent Document 1, for example).

### PRIOR ART

### Patent Document

[Patent Document 1] Japanese Patent Application Laid-Open Publication No. 2006-21631

### DISCLOSURE OF THE INVENTION

### Problems to be Solved by the Invention

However, there is a case that the irradiation direction of the headlamp of the vehicle may be directed to a light source with no implications for the vehicle in the prior art as described above, and as a result, there is a possibility that a position that should be illuminated (a position where pedestrians exist on a road side, for example) by the headlamp may not be illuminated.

The present invention has been made in light of the problems set forth above and has as its object to enhance a reliability of an irradiation direction control in a technology that detects a position of a light source based on an image acquired by an on-vehicle camera, and controls an irradiation direction of a headlamp of a vehicle directed to the detected position by improving a determination of whether to direct the irradiation direction to the detected light source or not.

### Means for Solving the Problems

In order to achieve the above object, claim 1 of the invention is a vehicle headlamp control system including a means for acquiring position information of a light source that acquires the position information from an image sensor, which images surroundings of a vehicle, detects the light source based on an acquired image, and outputs the position information of the light source, a means for determining whether there is the light source within a predetermined traveling direction range of the vehicle based on the position information of the light source acquired by the means for acquiring the position information of the light source, and a means for controlling a headlamp that controls an irradiation direction of the headlamp to follow a direction of the light source if a determination result of the means for determining is positive, and controls the headlamp independently from the position of the light source if a determination result of the means for determining which is negative.

Thereby, since a control to follow the light source is not performed unless the light source is within the traveling direction range of the vehicle even if the light source is detected, a possibility that a situation where a desired position is not irradiated as a result of facing the irradiation direction toward the light source that does not affect the vehicle necessarily decreases, thus the reliability of the control of the irradiation direction increases.

Claim 2 of the invention is the vehicle headlamp control system according to claim 1, wherein, the means for determining determines the traveling direction range based on a steering angle or a yaw rate of the vehicle.

By doing so, it is possible to identify an appropriate traveling direction range of the vehicle based on a traveling condition of the vehicle.

Claim 3 of the invention is the vehicle headlamp control system according to claim 1, wherein, the means for determining determines the traveling direction range based on shape information of a road where the vehicle is currently traveling.

By doing so, it is possible to identify the appropriate traveling direction of the vehicle based on the shape of the road where the vehicle is traveling.

Claim 4 of the invention is the vehicle headlamp control system according to any one of claims 1 to 3, wherein, the means for controlling determines whether or not the light source is of another vehicle when the determination result of the means for determining is negative, controls the headlamp to a low beam when the light source is determined to be of another vehicle, and controls the headlamp to a high beam when the light source is not determined to be of another vehicle.

Further, even if the light source is determined not to affect the vehicle necessarily and the headlamp is not made to follow the light source actively, there is a possibility that the light source may enter within the irradiation range of the headlamp.

Therefore, the probability of irradiation the vehicle with the high beam is reduced when the low beam and the high beam are used properly depending on whether the light source belongs to the other vehicle or not.

### BRIEF DESCRIPTION OF THE DRAWINGS

FIG. 1 is a block diagram of a vehicle headlamp control system according to an embodiment of the present invention.

FIGS. 2 (a), (b) and (c) are diagrams illustrating control modes of irradiation directions and irradiation ranges of headlamps, respectively.

FIG. 3 is a flowchart of a process executed by an ECU.

FIG. 4 is a diagram illustrating a traveling direction range of a vehicle determined depending on a detected value of a steering angle.

FIG. 5 is a diagram illustrating the traveling direction range of the vehicle determined depending on a detected value of a yaw rate.

FIG. 6 is a diagram showing a head lamp control according to the embodiment.

FIG. 7 is a diagram showing a headlamp control of a comparative example.

FIG. 8 is a diagram showing the head lamp control according to the embodiment.

FIGS. 9 (a) and (b) Illustrate the headlamp controls of the comparative examples, respectively.

FIG. 10 is a diagram illustrating the traveling direction range of the vehicle determined depending on a shape interpolation point or the like of a link.

FIG. 11 is a diagram illustrating the traveling direction range of the vehicle determined depending on a detected white line.

### MODE FOR CARRYING OUT THE INVENTION

### First Embodiment

Hereinafter, a first embodiment of the present invention will be described.

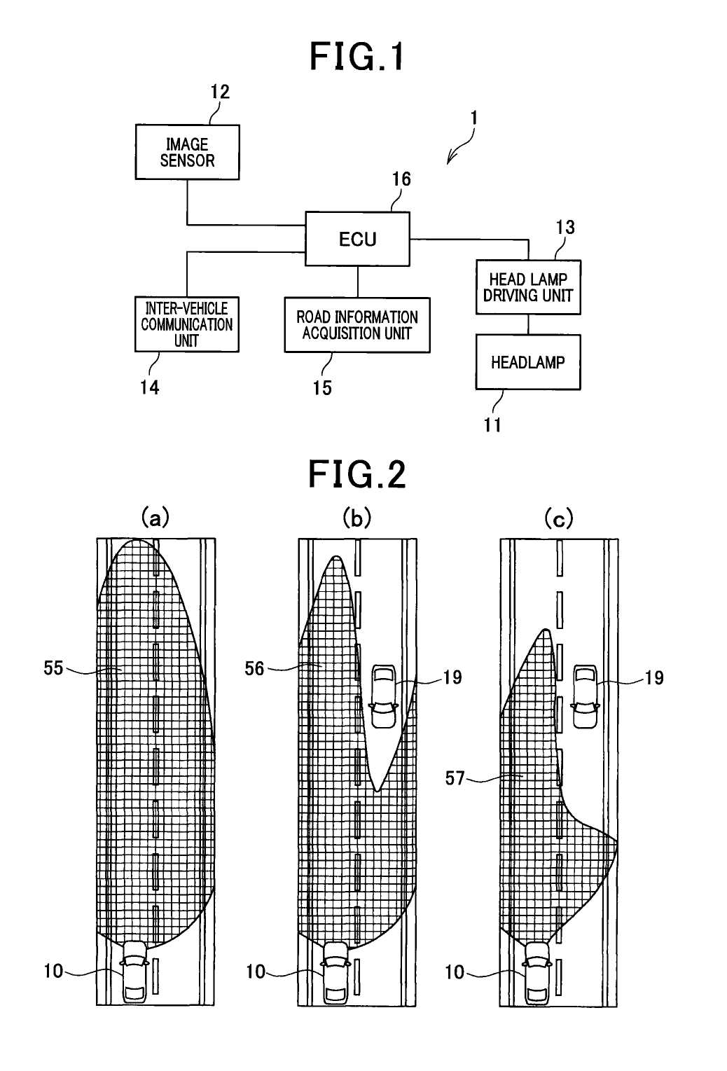

FIG. 1 shows a structure of a vehicle headlamp control system 1 according to the present embodiment.

The vehicle headlamp control system 1 is mounted in a vehicle and is a system for controlling two headlamps 11 of the vehicle, and includes an image sensor 12, a head lamp driving unit 13, an inter-vehicle communication unit 14, a road information acquisition unit 15, an ECU (electronic control unit) 16, and the like.

The image sensor 12 includes a camera section and a detection section.

The camera section repeatedly images ahead of the vehicle therefrom, and outputs images of acquired result successively to the detection section.

The detection section detects a light source (an object that can be recognized as a vehicle by a luminance equal to or greater than a predetermined value, a shape, a color, or the like) acquired in the image by applying a known detection processing to the images output from the camera section, and outputs position coordinates of the detected light source (for example, each position coordinate of a left end, a right end, and a lower end of the light source in the image) to the ECU 16 as a position information of the light source.

A head lamp driving unit 13 is an actuator for controlling turning on and off, an irradiation direction, an irradiation range, and the like of the head lamp 11.

The head lamp driving unit 13 has a swivel motor for changing (i.e., to swivel) the irradiation direction of the headlamp 11 in a lateral direction of the vehicle, a leveling motor for changing the irradiation direction of the headlamp 11 in a vertical direction of the vehicle, and a shutter that can be opened and closed for partially shielding the light of the headlamp 11 for each headlamp 11.

Control modes of the irradiation directions and the irradiation ranges of the head lamp 11 using the shutter is shown in FIG. 2.

FIG. 2 (a) shows the irradiation range 55 of the headlamp 11 of the vehicle 10 that has the vehicle headlamp control system 1 mounted at the time of a high beam, FIG. 2 (b) shows the irradiation range 56 of the headlamp 11 at the time of a lateral intermediate high beam after recognition of an oncoming vehicle, and FIG. 2 (c) shows the irradiation range 57 of the headlamp 11 when a right light is in a low beam (a left light is in the intermediate high beam).

At the time of the high beam shown in FIG. 2 (a), the left and right shutters open so that the irradiation range becomes the widest.

At the time of the intermediate high beam shown in FIG. 2 (b), left and right intermediate high beam shutters are closed so that the light of the headlamp 11 is partially shielded and the radiation range correspondingly narrows.

Thus, the light does not irradiate the oncoming vehicle 19 by reducing the irradiation range by partially shielding the light in the high beam.

At the time of the low beam shown in FIG. 2 (c), the intermediate high beam shutter of the right and a low beam shutter of the right close, thus the irradiation range becomes narrow.

The head lamp driving unit 13 controls the irradiation direction and the irradiation range of the headlamp 11 by switching irradiation modes between the high beam, the intermediate high beam, and the low beam as described above, as well as changing the irradiation direction of the head lamp 11 in the lateral direction of the vehicle by using the swivel motor.

The inter-vehicle communication unit 14 is a wireless device for communicating with communication devices of other vehicles.

The road information acquisition unit 15 acquires vehicle informations such as a current position, a course, a steering angle, a yaw rate, etc. of the vehicle from known sensors in the vehicle, and acquires information of road shapes on which the vehicle is currently traveling, then outputs the acquired information to the ECU 16.

The road information acquisition unit 15 may acquire information regarding the road shapes from a navigation system mounted on the vehicle.

In this case, the road information acquisition unit 15 requests from the navigation system the information of the road shapes, the navigation system then identifies the current position of the vehicle in a known manner in response to the request, identifies a link on which the vehicle is currently traveling based on the specified current position, reads out shape information of the identified link (position information of shape interpolation points and nodes) from the map data, and outputs the read out road shape information to the road information acquisition unit 15 as the information of the road shapes.

Alternatively, the road information acquisition unit 15 may acquire information regarding the road shapes using known white line detection methods.

In this method, the road information acquisition unit 15 acquires shapes of white lines on both sides of the road on which the vehicle is traveling by performing a known white line detection process to the images acquired by the camera section of the image sensor 12, and specifies the shape of the road ahead of the vehicle based on the shapes of the white lines acquired.

The ECU 16 is an electronic control unit having a microcomputer etc., and performs various processes for controlling the headlamp 11 by executing a program recorded in the ECU 16 in advance.

Hereinafter will be described an operation of the vehicle headlamp control system 1 configured as described above.

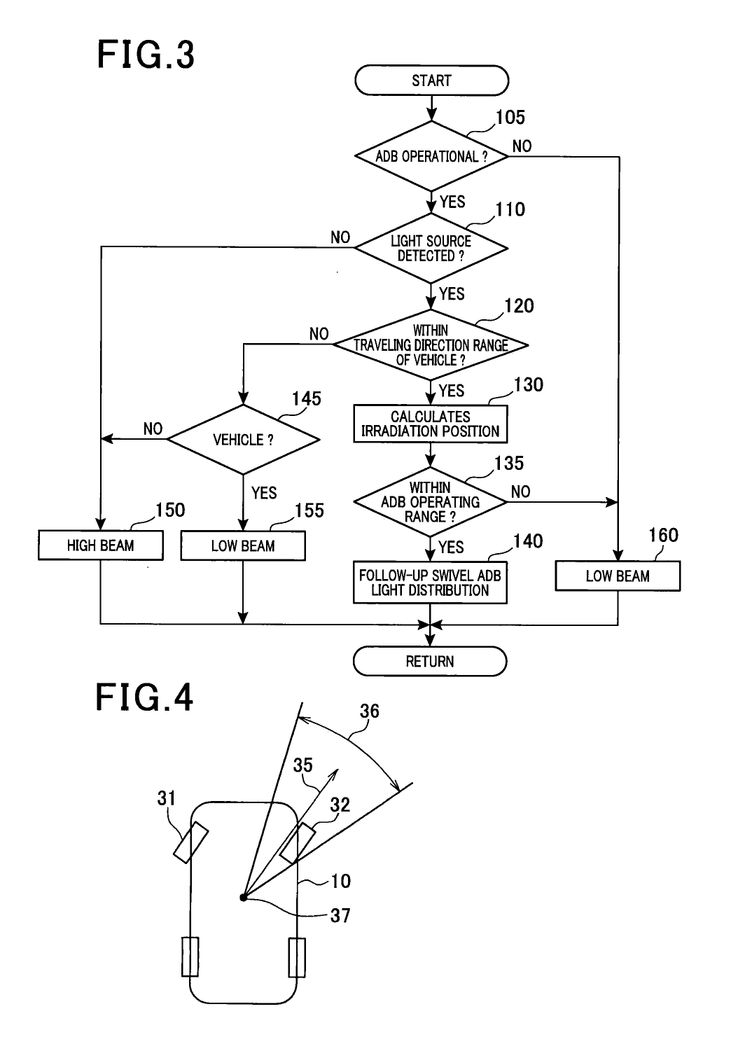

FIG. 3 shows a flowchart of a process that the ECU 16 performs during the vehicle 10 is traveling.

In the process of FIG. 3, the ECU 16 first determines whether an ADB (Adaptive Driving Beam) is operational at step 105.

Regarding whether the ADB is operational, the ADB becomes operational when the user turns on an operation switch (not shown), and the ADB becomes disabled when the user turns off the operation switch.

The process proceeds to step 160 when the ADB is disabled, and controls the head lamp driving unit 13 so that the headlamps 11 are in the low beam state, while the irradiation direction of the headlamps 11 on the left-right direction of the vehicle is fixed to the direction ahead of the vehicle (the direction to which a vehicle body is facing).

Or, if an AFS (Adaptive Front Light System) function is valid, an AFS motion is performed.

Note that regardless of whether the ADB is operational, the low beam is switched to the high beam or the high beam is switched to the low beam in response to the operation of a specific beam selector switch by the driver.

After step 160, the process returns to step 105.

When the ADB is determined operational at step 105, the process then proceeds to step 110 which is a means for acquiring position information of the light source, and determines whether a position information of the light source is outputted from the detection section of the image sensor 12, or whether the image sensor 12 has detected the light source according to information such that the high beam is switchable.

When it is determined that the light source is not detected, the process proceeds to step 150 that is a means for controlling the headlamp, and switch the headlamps 11 to the high beam by controlling the head lamp driving unit 13.

Further, when it is determined that the light source is detected, the process proceeds to step 120 that is a means for determining based on the position information of the light source.

In step 120, the position information outputted from the detection section of the image sensor 12 is acquired and it is determined whether there exists a corresponding light source within a traveling direction range of the vehicle 10 based on the acquired position information.

Specifically, the traveling direction range of the vehicle 10 is specified according to detected value of a speed of the vehicle 10 and one or both of a steering angle and/or a yaw rate acquired by the road information acquisition unit 15.

When the traveling direction range of the vehicle 10 is determined from the detected value of the vehicle speed and the steering angle, a turning radius is obtained from the vehicle speed and the steering angle, a traveling direction 35 of the vehicle 10 is specified from the turning radius, as shown in FIG. 4, and a predetermined range in the horizontal direction with respect to the traveling direction 35 that is a central direction (a range 36 up to 10° to the left and right from the central direction, for example, however, a center 37 for an angle setting is set to a center position of the vehicle 10) is determined as the traveling direction range of the vehicle 10.

As a method for determining the turning radius from the vehicle speed and the steering angle, a method of calculating a turning radius R by substituting the vehicle speed V and the steering angle δ (more specifically, steering angle of front wheels which are steered wheels) to the following expression is employed.

R=(1+A×V²)(L/δ(n/180°))

Here, A is a stability factor of the vehicle and L is a wheel base of the vehicle, and both are predetermined parameters for each vehicle.

Further, as a method for specifying the traveling direction 35 of the vehicle 10 from the turning radius R, a method of determining an angle β by substituting the vehicle speed V, the turning radius R, and a vehicle travel time t to the following expression is employed.

β=α/2={360°×V×t/(2πR)}/2

Here, the angle β is an angle of the traveling direction 35 relative to the front of the vehicle.

Further, the vehicle travel time is the time it takes for the vehicle to travel a predetermined distance (30 m or 100 m, for example), and a result of dividing a predetermined distance by the vehicle speed V is adopted.

Furthermore, when the traveling direction range of the vehicle 10 is determined from the yaw rate, a central direction 39 is set so that a clockwise angle θ from a direction 38 of the present vehicle body 10 increases as the yaw rate of a right rotation increases, as shown in FIG. 5, and a predetermined range in the horizontal direction with respect to the central direction 39 that is a center (a range 40 up to 10° to the left and right from the central direction, for example, however, the center 37 for the angle setting is set to the center position of the vehicle 10) is determined as the traveling direction range of the vehicle 10.

Whether the light source is within the specified traveling direction range is determined based on the position information of the light source obtained from the image sensor 12.

Specifically, in which direction that position coordinates included in the location information (i.e., the position coordinates of the light source in the acquired image) corresponds when viewed from the vehicle 10 is calculated, and determined whether the calculated direction is included in the traveling direction range or not.

Note, in which direction that the position coordinates of the acquired image corresponds when viewed from the vehicle is determined in advance based on a correspondence table recorded in a storage medium of the ECU 16.

The correspondence table can be calculated in advance and recorded in the storage medium of the ECU 16 if a mounting position, an orientation and the like of the camera section of the image sensor 12 are decided.

When it is determined that there is the corresponding light source is within the traveling direction range of the vehicle 10, the process proceeds to step 130 that is a means for controlling the headlamp, and calculates an irradiation position.

Specifically, the direction of the corresponding light source as viewed from the vehicle 10 is calculated using the position coordinates of the corresponding light source obtained and the correspondence table, and the irradiation direction of the headlamp 11 (direction in the horizontal direction of an optical axis of the vehicle 10) is determined so that the corresponding light source is to be located in the center in the lateral direction of the irradiation range of the headlamp 11, thereby the irradiation direction determined is set to the irradiation position.

Subsequently, step 135 determines whether the calculated irradiation position is within an ADB operating range.

The ADB operating range is a range that can change the direction of the optical axis of the head lamp 11 by the control of the head lamp driving unit 13, and an ADB operating range data showing the ADB operating range is stored in the storage medium of the ECU 16 in advance corresponding to performances of the headlamp 11 and the head lamp driving unit 13.

When the ECU 16 determines that the irradiation position is not within the ADB operating range based on the ADB operating range data, the process proceeds to step 160 that is a means for controlling the headlamp, and performs the operation previously described.

Further, when it is determined that the irradiation position is within the ADB operating range, the process proceeds to step 140 that is a means for controlling the headlamp.

In step 140, a follow-up swivel is realized by performing a control of the irradiation direction of the headlamp 11 to follow in the direction of the light source.

That is, the swivel motor of the head lamp driving unit 13 is controlled so as to attempt to realize the irradiation position calculated in step 130 to the headlamp 11. Further in step 140, an ADB light distribution is realized.

That is, since there is a possibility that the light source is headlamps of another vehicle, the headlamp 11 is switched to either the intermediate high beam or the low beam depending on the position of the light source so that the light of the headlamp 11 may not be exposed upon the light source directly. After step 140, the process returns to step 105.

On the other hand, when it is determined that there is no corresponding light source within the traveling direction range of the vehicle 10 in step 120, the process proceeds to step 145, and the light source is determines whether a light is of another vehicle.

This determination is performed, for example, in the following manner.

The ECU 16 transmits a polling signal around the vehicle 10 by using the inter-vehicle communication unit 14.

If the light source is the light of the other vehicle, and the other vehicle has an inter-vehicle communication unit, the inter-vehicle communication unit of the other vehicle receives the polling signal, a current position coordinates of the other vehicle (e.g., latitude and longitude) is acquired based on a reception of the signal, and transmits the current position coordinates to the inter-vehicle communication unit 14 of the transmission source.

The inter-vehicle communication unit 14 then outputs the current position coordinates of the other vehicle received to the ECU 16.

Then, the ECU 16 specifies a traveling direction of the other vehicle viewed from the own vehicle 10 by comparing the current position coordinates and the orientation of the own vehicle acquired from the road information acquisition unit 15 and the position coordinates of the other vehicle acquired from the road information acquisition unit 15, and when the specified direction of the other vehicle and the direction of the light source specified in step 130 (the irradiation position) match within a predetermined error range, or when traveling information of the other vehicle (e.g., information of distance between preceding vehicles, information of an approach vehicle or the like) is received, it is determined that the light source is of the other vehicle, and it is determined that the light source is not of the other vehicle if do not match.

When the light source is determined not of another vehicle, the process proceeds to step 150 subsequently, and controls the head lamp driving unit 13 so that it becomes the high beam, and the irradiation direction of the headlamp 11 on the left-right direction of the vehicle is changed so that the irradiation direction of the headlamp 11 faces the traveling direction of the vehicle 10 according to the steering angle and the vehicle speed of the vehicle 10.

The control of the irradiation direction is performed independently from the position of the detected light source.

Or, the irradiation direction of the headlamp 11 on the left-right direction of the vehicle is fixed to the front of the vehicle (the direction to which the vehicle body is facing).

After step 150, the process returns to step 105.

When the light source is determined to be the light of the other vehicle, the process proceeds subsequently to step 155 that is a means for controlling the headlight, and controls the head lamp driving unit 13 so that it becomes the low beam, and the irradiation direction of the headlamp 11 on the left-right direction of the vehicle is changed so that the irradiation direction of the headlamp 11 faces the traveling direction of the vehicle 10 according to the steering angle and the vehicle speed of the vehicle 10.

The control of the irradiation direction is performed independently from the position of the detected light source.

Or, the irradiation direction of the headlamp 11 on the left-right direction of the vehicle is fixed to the front of the vehicle (the direction to which the vehicle body is facing).

After step 155, the process returns to step 105.

Accordingly, although the position information of the light source is acquired from the image sensor 12 (step 110), it is determined whether or not there is a corresponding light source within the traveling direction range of the vehicle 10 determined in accordance with the detected value of the steering angle or the yaw rate of the vehicle 10 based on the position information of the light source (step 120), and the irradiation direction of the headlamp 11 is controlled to follow the direction of the light source if the determination result is positive (steps 130-140), the head lamp 11 is controlled independently from the position of the detected light source when the determination result is negative.

Thereby, since the control to follow the light source is not performed unless the corresponding light source is within the traveling direction range of the vehicle that is determined in accordance with the detected value of the steering angle or the yaw rate of the vehicle even if the light source is detected, a possibility that a situation where a desired position is not irradiated as a result of facing the irradiation direction toward the light source that does not affect the vehicle necessarily decreases, thus the reliability of the control of the irradiation direction increases.

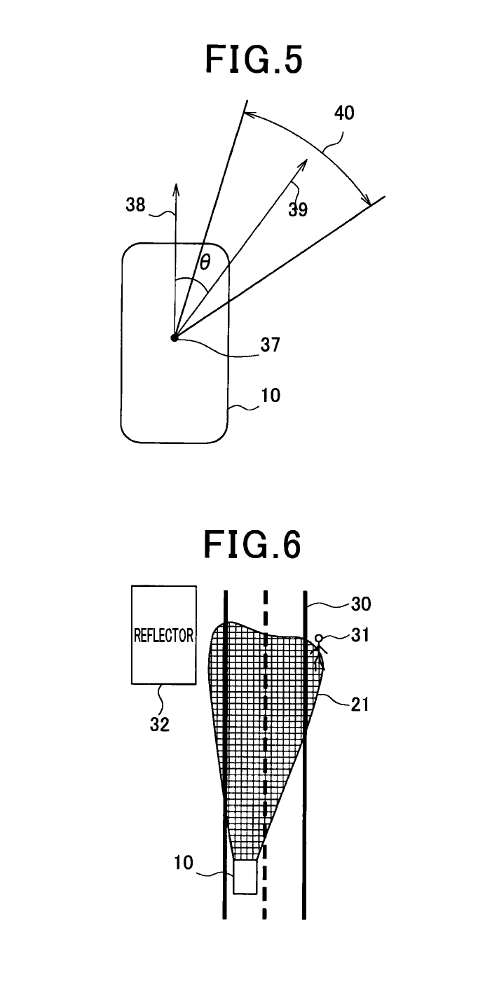

As shown in FIG. 6, for example, even if a reflector 32 outside a road 30 is detected as a light source during the vehicle 10 is traveling in the straight road 30, the irradiation direction of the headlamp 11 does not follow the reflector 32 when it is determined that the light source is not within the traveling direction range of the vehicle that is determined in accordance with the detected value of the steering angle or the yaw rate of the vehicle, therefore an irradiation range 21 of the head lamp 11 becomes a straight direction as usual, and as a result, when there is a pedestrian 21 on a side of the road 30, the pedestrian can be irradiated.

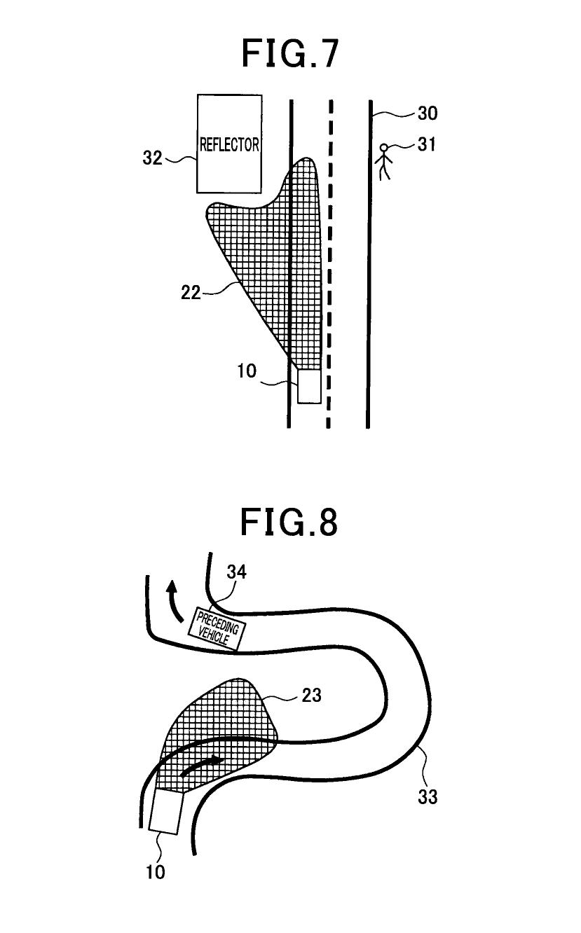

On the other hand, when the reflector 32 outside of the straight road 30 is detected as the light source during the vehicle 10 is traveling on the road 30, as shown in FIG. 7, and if the irradiation direction of the headlamp 11 is made to follow the reflector 32 unconditionally even if the light source is not within the traveling direction range, the desired position is not irradiated, and a possibility that the pedestrian 31 is missed increases.

In addition, for example, as shown in FIG. 8, even if a light of a vehicle 34 existing far ahead along the road 33 is detected as the light source during the vehicle 10 is traveling a meandering road 33, the irradiation direction of the headlamp 11 does not follow the vehicle 34 when it is determined that the vehicle 34 is not within the traveling direction range of the vehicle that is determined in accordance with the detected value of the steering angle or the yaw rate of the vehicle, therefore an irradiation range 23 of the head lamp 11 faces the direction according to the steering as usual, and as a result, the road ahead can be irradiated.

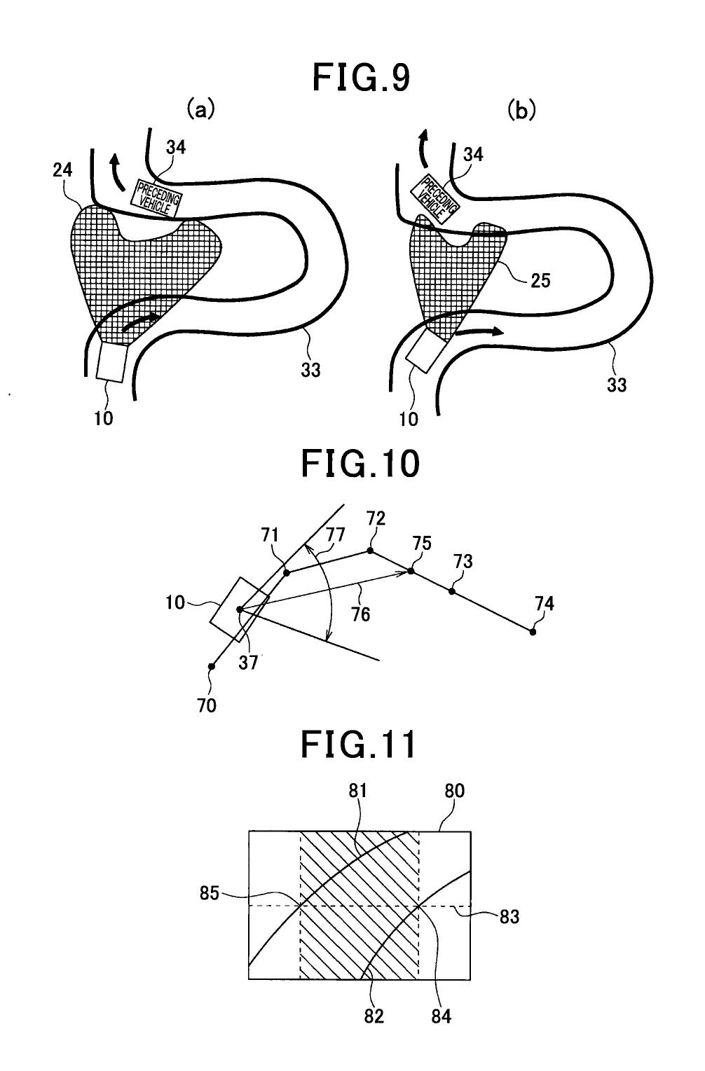

On the other hand, when the light of the vehicle 34 existing far ahead along the road 33 is detected as the light source during the vehicle 10 is traveling the road 33, as shown in FIGS. 9 (a) and (b), and if the irradiation direction of the headlamp 11 is made to follow the vehicle 34 unconditionally even if the vehicle 34 is not within the traveling direction range, the desired position is not irradiated, and a possibility that a visibility of the road immediately ahead is deteriorated increases.

Thereby, since the control to follow the light source is not performed unless the corresponding light source is within the traveling direction range of the vehicle that is determined in accordance with the detected value of the steering angle or the yaw rate of the vehicle even if the light source is detected, a possibility that a situation where a desired position is not irradiated as a result of facing the irradiation direction toward the light source that does not affect the vehicle necessarily decreases, thus the reliability of the control of the irradiation direction increases.

Moreover, it is possible to identify the appropriate traveling direction range of the vehicle based on a traveling condition of the vehicle.

Further, even if the light source is determined not to affect the vehicle necessarily and the irradiation direction of the headlamp 11 is not made to follow the light source actively as in step 155, there is a possibility that the light source may enter within the irradiation range of the headlamp.

Therefore, the probability of irradiation the vehicle with the high beam is reduced when the low beam and the high beam are used properly depending on whether the light source belongs to the other vehicle or not.

### Second Embodiment

Next, a second embodiment of the present invention will be described.

The present embodiment is different from the first embodiment in a processing content in step 120 shown in FIG. 3.

Hereinafter, the processing content will be described.

The components identical with or similar to those in the first embodiment are given the same reference numerals for the sake of omitting explanation.

In the present embodiment, the process is the same as the first embodiment in that the ECU 16 acquires the position information outputted from the detection section of the image sensor 12 in step 120, it is determined whether there is the light source within the traveling direction range of the vehicle 10 based on the position information acquired, the process proceeds to step 130 if the determination is affirmative, and the process proceeds to step 135 if it is negative.

However, a method of calculating the traveling direction range of the vehicle 10 is different from that of the first embodiment.

Although the traveling direction range is specified according to detected value of one or both of the steering angle and/or the yaw rate acquired by the road information acquisition unit 15 in the first embodiment, the traveling direction range is determined based on the shape information of the links currently being travelled along that the road information acquisition unit 15 acquires from the navigation system, or is determined based on the shape information of the road currently traveling identified using the white line detection by the road information acquisition unit 15 in the present embodiment.

When determining the traveling direction range based on the shape information of the currently traveling links acquired from the navigation system, a line that connects shape interpolation points 71 to 73 and nodes 70 and 74 in sequence is calculated based on position coordinates of the shape interpolation points 71, 72, and 73 and the position coordinates of the nodes 70 and 74 included in the shape information of the link as shown in FIG. 10, a point 75 is used as a reference point advanced forward from the vehicle 10 along a line with a predetermined distance (30 m for example), a direction 76 from the center 37 of the vehicle 10 toward the center of the reference point 75 is set as a central direction, and a predetermined range in the horizontal direction with respect to the central direction 76 (a range 77 up to 30° to the left and right from the central direction 76, for example, however, a center 37 for an angle setting is set to a center position of the vehicle 10) is determined as the traveling direction range of the vehicle 10.

When the traveling direction range is determined based on the shape information of the road currently driving identified by the white line detection, among white lines of the left and right ends 81 and 82 of a road identified in an acquired image 80 by the white line detection, a predetermined position, for example, points 84 and 85 where an imaginary center line 83 of a center in a vertical direction of the acquired image 80 and the white lines 81 and 82 intersect are identified as shown in FIG. 11, and a range from a direction corresponding to the identified point 85 to a direction corresponding to the identified point 84 (the shaded range in FIG. 11) is identified as the traveling direction range of the vehicle 10.

Accordingly, it is possible to identify the appropriate traveling direction of the vehicle based on the shape of the road where the vehicle is traveling in the present embodiment.

### DESCRIPTION OF REFERENCE NUMERALS

1 vehicle headlamp control system
11 head lamp
12 image sensor
13 head lamp driving unit
14 inter-vehicle communication unit
15 road information acquisition unit
16 ECU

1. A vehicle headlamp control system comprising:
a means for acquiring position information of a light source that acquires the position information from an image sensor, which images surroundings of a vehicle, detects the light source based on an acquired image, and outputs the position information of the light source;
a means for determining whether there is the light source within a predetermined traveling direction range of the vehicle based on the position information of the light source acquired by the means for acquiring the position information of the light source; and
a means for controlling a headlamp that controls an irradiation direction of the headlamp to follow a direction of the light source if a determination result of the means for determining is positive, and controls the headlamp independently from the position of the light source if a determination result of the means for determining is negative, wherein,
the means for determining determines the traveling direction range based on a steering angle or a yaw rate of the vehicle.

2-4. (canceled)

5. The vehicle headlamp control system according to claim 1, wherein,
the means for controlling determines whether or not the light source is of another vehicle when the determination result of the means for determining is negative, controls the headlamp to a low beam when the light source is determined to be of another vehicle, and controls the headlamp to a high beam when the light source is not determined to be of the other vehicle.

6. A vehicle headlamp control system comprising:
a means for acquiring position information of a light source that acquires the position information from an image sensor, which images surroundings of a vehicle, detects the light source based on an acquired image, and outputs the position information of the light source;
a means for determining whether there is the light source within a predetermined traveling direction range of the vehicle based on the position information of the light source acquired by the means for acquiring the position information of the light source; and
a means for controlling a headlamp that controls an irradiation direction of the headlamp to follow a direction of the light source if a determination result of the means for determining is positive, and controls the headlamp independently from the position of the light source if a determination result of the means for determining is negative, wherein,
the means for determining determines the traveling direction range based on shape information of a road where the vehicle is currently traveling.

7. The vehicle headlamp control system according to claim 6, wherein,
the means for controlling determines whether or not the light source is of another vehicle when the determination result of the means for determining is negative, controls the headlamp to a low beam when the light source is determined to be of another vehicle, and controls the headlamp to a high beam when the light source is not determined to be of the other vehicle.

8. A vehicle headlamp control system comprising:
a means for acquiring position information of a light source that acquires the position information from an image sensor, which images surroundings of a vehicle, detects the light source based on an acquired image, and outputs the position information of the light source;
a means for determining whether there is the light source within a predetermined range in a horizontal direction of a traveling direction of the vehicle among a front of the vehicle based on the position information of the light source acquired by the means for acquiring the position information of the light source; and
a means for controlling a headlamp that controls an irradiation direction of the headlamp to follow a direction of the light source if a determination result of the means for determining is positive, and controls the headlamp independently from the position of the light source if a determination result of the means for determining is negative.

9. The vehicle headlamp control system according to claim 8, wherein,
the means for controlling determines whether or not the light source is of another vehicle when the determination result of the means for determining is negative, controls the headlamp to a low beam when the light source is determined to be of another vehicle, and controls the headlamp to a high beam when the light source is not determined to be of the other vehicle.
